(19) United States
(12) Patent Application Publication
(10) Pub. No.: US 2004/0157546 A1
(43) Pub. Date: Aug. 12, 2004

(54) Wireless leisure management system

(76) Inventor: Jordan Fantaay, Clifton (GB)

Correspondence Address: SAWYER LAW GROUP LLP, P O BOX 51418, PALO ALTO, CA, 94303, US

(21) Appl. No.: 10/364,837

(22) Filed: Feb. 10, 2003

(51) Int. Cl. H04H 1/00

(52) U.S. Cl. 455/3.03; 455/456.3

(57) ABSTRACT

A leisure management system for use in leisure facilities comprising fixed and mobile transceiver units. A mobile unit is assigned to a customer at the facility and provides the customer with audio entertainment. The mobile unit transmits telemetry and other data from the customer to the fixed transceiver units. The signal strength of the signal used to transmit data from the mobile unit to at least two fixed units is used to locate the mobile unit within the leisure facility. This information is used to provide relevant control information to equipment within the facility.

The present invention relates to a wireless local area network for enhancing and controlling leisure activities, and particularly to such a system adapted for use in a health and fitness centre environments.

### BACKGROUND OF THE INVENTION

When exercising, people often like to listen to music. Mainly as a result of the background noise generated in a gymnasium type environment, it is often not possible for music to be played through a conventional sound system and personal sound systems incorporating headphones have become popular. However, for commercial or safety reasons, it can be important for the management of a leisure facility to control the sound tracks available to a client during exercise, and hence local sound distribution systems have been developed.

Traditionally, sound distribution systems, particularly those used in the gymnasium environment, have been based on wired networks. A central sound source generates an analogue sound signal, which is transmitted through a wired network to a series of audio units. The units have a socket for headphones and provide channel and volume controls. The terminals are located at various convenient locations around a building and may, for example, be attached to each piece of exercise equipment within a gymnasium. A user is able to plug his or her personal headphones into one of these terminals and listen to one of a number of audio channels.

Some gymnasiums now use a semi-wired system whereby power only is wired to the terminals and the sound signal is transmitted as a standard, short range, FM radio signal. Battery operated units have not traditionally been used in the gymnasium environment, partly because of the effect of the size and weight of such units on a user's freedom to exercise.

The traditional systems suffer from a number of disadvantages. Firstly, it is necessary to install cabling into the building to provide power and/or sound signals to the terminals. This can be disruptive, expensive and difficult to re-arrange. Secondly, the user cannot listen to music unless their receiver is plugged in to a terminal; they are not free to move around the building without disrupting their listening. Thirdly, long signal cables tend to distort the music quality as a result of the effect of the resistance of the cables on the amplifier circuit and analogue FM radio transmission is susceptible to noise, particularly at the low power levels used for local transmissions.

Leisure facilities are generally managed by a number of supervisors or other managers. In a gymnasium, fitness instructors may also be involved in managing clients. At present, management generally rely on seeing where a client is or what he or she is doing and speaking face to face in order to obtain feedback from or provide instructions to the client. In a gymnasium, management may also require bio-data, such as a client's pulse rate, for safety reasons or to chart the improving fitness of a client. In order to obtain such data, the client must be taken aside and the necessary measurements taken using conventional equipment and recorded using pen and paper or manually input into a computer based client data management system.

In the gymnasium environment, a client may have a particular exercise routine that they desire to follow. This will involve sequentially using various pieces of exercise equipment at particular settings for particular periods of time. A client, or his or her fitness trainer, is required to input control data to each piece of exercise equipment before the client begins to use it. This often involves an electronic control system requiring the user to select from a number of options using a keypad and display screen. The user must therefore not only remember the settings required but also the particular sequence of keypad strokes required to input the information to the equipment.

What is needed is an integrated leisure management system comprising an easy to install system that can provide high quality sound to clients anywhere in a leisure facility and transmit data back to a central system. It would be advantageous if such a system could also provide control information to equipment used by the client to enhance a client's experience at the facility.

### SUMMARY OF THE INVENTION

The present invention comprises a system for managing a leisure facility comprising: a processing unit; a plurality of fixed transceiver units; and a mobile transceiver unit allocated to a customer, wherein at least two fixed transceivers receive radio signals from the mobile unit; and the processing unit uses the relative strength of the signals to determine the position of the mobile transceiver within the leisure facility.

Preferably, the mobile transceiver unit provides an audio output stream to the customer. Preferably, the fixed transceiver unit comprises a plurality of buffers each associated with a different input audio channel and containing a data packet representing a sample from said audio channel and the mobile transceiver comprises a channel selector, wherein the mobile unit requests a sample from a particular channel and in response, the fixed transceiver unit transmits the content of the buffer associated with the selected channel to the mobile receiver unit.

Preferably, the processing unit uses the position of the mobile transceiver unit to determine which equipment, of a plurality of equipment located within the leisure facility, is being used by the customer.

Preferably, the processing unit provides stored information about the customer to the equipment being used by the customer. The equipment may be exercise equipment and the stored information about the customer may relate to an exercise programme being followed by the customer. The stored information is preferably transmitted wirelessly via the fixed transceiver units.

Preferably, the processing unit uses the position of the mobile transceiver unit to sound an alarm when a customer leaves a predetermined area.

In another embodiment, the present invention comprises a method comprising, in a leisure facility: allocating a uniquely identifiable mobile unit to each customer; tracking the position of the mobile unit within the facility; using said information, in combination with stored information about a customer to control interactive equipment within the facility.

Preferably, the mobile unit provides an audio output stream to the customer.

In another embodiment, the present invention comprises a system for managing a leisure facility comprising: a fixed transceiver unit; and a mobile transceiver unit allocated to a customer, wherein the mobile transceiver unit provides an audio output stream to the customer and transmits data to the fixed transceiver unit.

Preferably, the data transmitted to the fixed receiver unit comprises bio-data measured by sensors on the customer.

Preferably, the strength of the signal used to transmit data from the mobile transceiver unit to the fixed transceiver unit is used to calculate the position of the mobile transceiver unit.

### BRIEF DESCRIPTION OF THE DRAWINGS

The invention will now be described with reference to the following drawings:

FIG. 1 shows the main components of one embodiment of a leisure management system according to the present invention. The zig-zag arrows in the figure represent radio communication links.

FIG. 2 shows a schematic diagram of the main components of the sound distribution system according to one embodiment of the present invention.

FIG. 3 shows a schematic diagram of the mobile module locator system according to one embodiment of the present invention.

FIG. 4 shows the format of the audio data packet used in one embodiment of the present invention.

### DETAILED DESCRIPTION

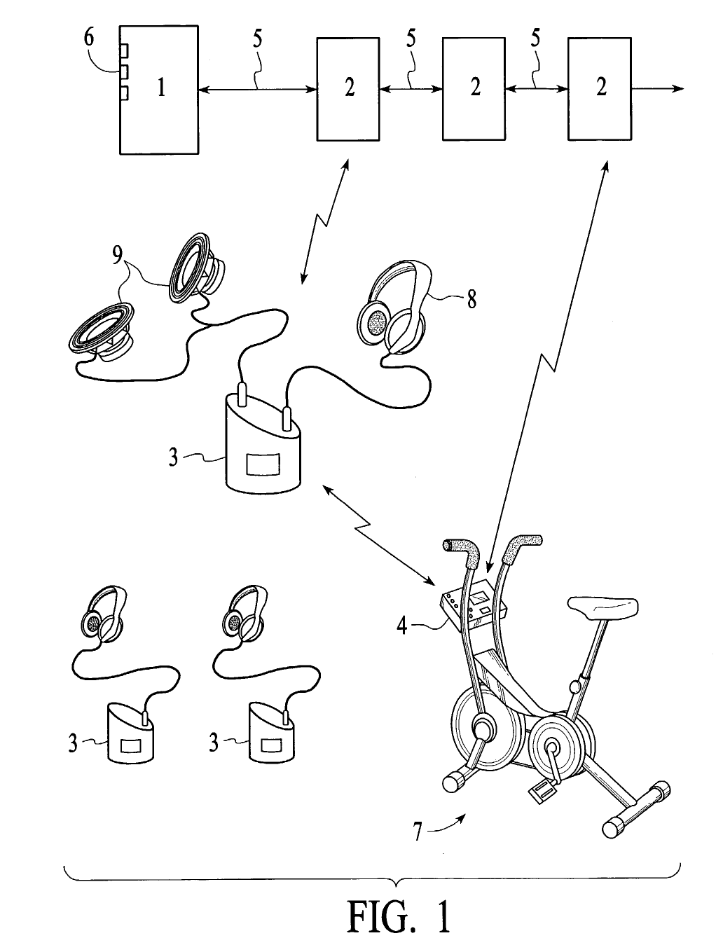

FIG. 1 illustrates the main components of a leisure management system according to the present invention adapted particularly to use in a gymnasium. A gateway module 1 encodes audio information which is transmitted by cable to base modules 2 and then wirelessly to mobile modules 3 which make the audio signal available to a mobile user via headphones 8.

The gateway module 1 is connected via a single cable 5 to a plurality of base modules 2 in a daisy chain network configuration. The single cable 5 contains data lines allowing duplex communication between the gateway module 1 and the base modules 2 and a power cable to provide power from the gateway module 1 to the base modules 2. This arrangement minimises the cabling necessary to implement the system. The gateway module has a plurality of input connectors 6 for receiving audio signals in different formats. The gateway module 1 converts these signals to a single digital format and forwards them to the base modules 2 via the cable 5.

The base modules 2 also receive data from the mobile modules 3. This may be telemetry data comprising reading from sensors 9 recording, for example a user's heart rate, blood pressure, body temperature or skin resitivity. It may also be a locator signal, used to determine the position of the mobile module within the facility. In the preferred embodiment the locator signal is separate from telemetry and other communication signals (such as sound data request and acknowledge signals). However, these signals could be used as locator signals to reduce the overall number of transmissions.

Most modern gymnasium equipment now features a “C-safe” connector. This connector allows electronic control of the equipment by external devices using a standard well known in the industry and allows the equipment to supply electronic telemetry and other output data to external devices.

In the preferred embodiment, the leisure management system also comprises equipment control modules 4 each associated with a piece of exercise equipment and electronically connected to the C-safe connector of that equipment. If there is no C-safe connector on the equipment, the control modules 4 can still exchange data, such as the type of equipment and setting options available, with the fixed modules 2. The equipment control modules 4 communicate wirelessly with the base modules 2 and can thus receive control information from the gateway module 1 and transmit telemetry data from the equipment back to the gateway module 1. The control modules 4 can also communicate directly with the mobile modules 3.

The gateway module 1 stores information relating to a particular client's exercise programme. When a locator unit 42 calculates that the client is approaching a particular piece of exercise equipment 7, it can send control information, via a selected base module 2, to the control module 4 attached to that equipment 7, in order to prepare the equipment for the client. The gateway module 1 can also alert the management or, preferably via the mobile module 3, the client if he or she is attempting to use the wrong piece of equipment.

In the preferred embodiment, the base module 2, mobile module 3 and control module 4 components of the system all communicate using the IEEE 802.11 Wireless LAN protocol via radio links.

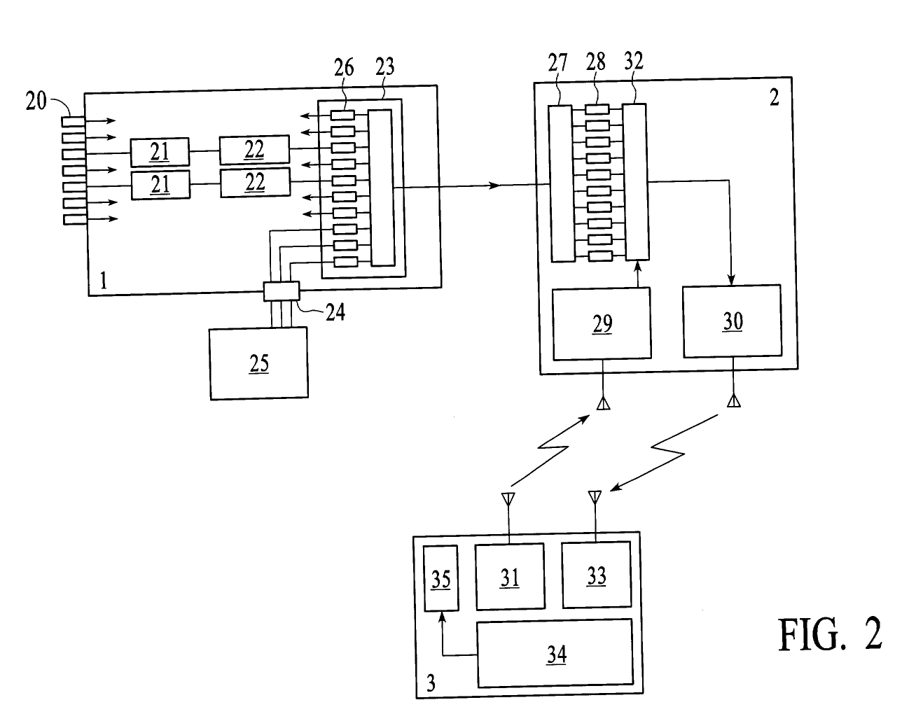

FIG. 2 is a schematic diagram showing a preferred implementation of the sound distribution components of the leisure management system. In a preferred embodiment, the gateway module 1 has ten input connectors 20 adapted to receive analogue audio signals in stereo format (seven shown). Each analogue signal is sent to an analogue to digital converter 21 that converts each analogue signal into a digital data stream. Each input connector 20 has a separate analogue to digital converter 21 (only two shown) so that multiple channels can be digitised simultaneously. Each digital data stream is forwarded to an encoder unit 22. This unit first compresses the data to allow more audio channels to be transmitted without significant sound distortion. The exemplary embodiment achieves a compression ratio of 16:1 using the Dolby® Advanced Audio Coding (AAC) algorithm. The encoder unit 22 then breaks up the data stream into data packets of between 0 and about 2000 bytes in length, depending upon the audio input. The more silence in the particular sample of the audio stream, the smaller the data packet. As shown in FIG. 4, each data packet comprises four significant fields of data. Sequentially, the field in a particular packet contain: a header clock + control field 51 which contains control & synchronisation information for the receiving module (address etc), and identification of the channel to which the data relates; a music info field 52 which contains information about the type of music in the packet (For example, Rock, Soul, T.V. sound etc.); audio data 53; and a cyclic redundancy check 54 for error detection. Note that T.V. sound must be delayed so that it is synchronised with the TV picture. The encoder units 22 then forward the data packets to a multiplexer unit 23.

It is possible for a digital audio signal to be input directly to the encoder unit 22 from a suitable source of serial digital data.

The preferred embodiment also has an input connector 24 adapted to receive pre-encoded data from a data storage medium 25. Sound signals are passed through a digital to analogue converter (if necessary) and encoded into the format described above. The digital data generated is then stored on a Compact Disc (CD), Digital Versatile Disc (DVD) or in a computer memory and can be delivered directly to the multiplexer unit via input connector. In a preferred embodiment, this encoded data represents ten pre-multiplexed channels (only three channels shown). The pre-encoding of audio signals reduces the need for an excessive numbers of analogue to digital converters 21, compression and encoder units 22 while allowing a large number of audio channels to be broadcast. The storage unit 25 is external to the gateway module 1 but it could also be integrated into the gateway module 1.

In a first embodiment (shown), the multiplexer unit 23 combines the data packets into a single data stream. Each channel is given a time slot during which a data packet relating to that channel is sent to the base units 2. The pre-encoded channels are given a number of time slots equal to the number of pre-encoded channels to ensure that each channel receives sufficient bandwidth. Each channel input to the multiplexer unit 23 has an input buffer 26 that holds the next packet from that channel for transmission. The multiplexer unit 23 cycles through each of these input buffers 26 in turn. When it finds a buffer 26 containing a data packet ready for transmission, that packet is forwarded to the base module 2. Following transmission, or if a buffer 26 is empty when checked, the multiplexer unit 23 moves to the next buffer 26. On reaching the base module 2, the multiplexed data stream is decoded (in decoder unit 27) into separate data packets relating to each channel and the data packet most recently received for each channel is stored in a buffer 28 relating to that channel in the base module 2. A mobile module 3 transmits a data request relating to a particular channel via a mobile transmitter unit 31. A base receiver unit 29, within the base module 2, receives this request and forwards it to a selector unit 32. The selector unit 32 presents the contents of the buffer 28 relating to the requested channel to the base transmitter unit 30, which transmits it to the mobile module 3. The data packet is received by a mobile receiver unit 33 and decoded in a mobile decoder unit 34. It is then forwarded to a digital to analogue converter 35 to generate an audio output signal for the user.

In a second embodiment (not shown), on reaching the base module 2, the entire multiplexed data stream is broadcast. All the mobile modules 2 receive this broadcast and each decodes it into separate data packets. Each mobile module 2 then compares a channel field in the header of each received data packet with the channel selected on its channel selector. If the packet does relate to the channel selected on the mobile module 2, the packet is streamed to a digital to analogue converter to provide the audio output to the user. If the packet does not relate to the channel selected on the mobile module 2, it is discarded.

In a third embodiment (not shown), the multiplexer 23 comprises a plurality of buffers, one relating to each available sound channel. Each buffer contains a data packet representing the most recently encoded sample of the relevant audio track. The base module 2 receives a request for sound data from a particular channel from the mobile module 3. It forwards this request to the gateway module 1 via the cable 5. The gateway module 1 transmits the data stored in the buffer relating to the selected channel to the base module 2 via the cable 5. The base module 2 then transmits the data packet to the mobile module 3 that originally requested the data.

In the preferred embodiment of the present invention the encoder unit 22 and multiplexer unit 23 are implemented in software, but hardware implementation and implementation using any combination of hardware and software is possible. Similarly, various units within the base modules 2 and the mobile modules 3 are preferably implemented in software but may be implemented in hardware.

The ergonomic design of the mobile modules 3 facilitates use in a gymnasium type environment. The mobile module 3 is about palm size, and its slender profile and contoured shape allow it to fit into a conventional track-suit or trouser pocket without interfering with the movement of the user. A waist belt with a pocket for the mobile module 3 can also be used. The mobile module 3 may also be deposited in specially designed holders attached to exercise equipment 7.

The mobile module 3 is connected by a jack arrangement to personal headphones 8. It has a channel control that can be adjusted by the user to select the required audio channel. The mobile module 3 receives the radio signal from a base module 2 via an internal aerial.

In the first and third embodiments above, the mobile module 3 regularly requests new data packets relevant to the channel selected on the channel control from a base module 2 using IEEE 802.11. The mobile module 3 initially selects a first base module 2 from which to request the data packet. If it receives no response from the selected base module 2 within a fixed time period, it assumes this module is out of range and requests the next base module 2 to provide the data packet. The sequence in which the base modules 2 are tried is pre-set. If no response is received from the last base module 2 in the sequence the mobile module 3 loops back to try the first base module 2.

Since IEEE 802.11 specifies a carrier sense multiple access with collision avoidance protocol, only one transmitter can be in operation at any one time. However, each base module 2 can communicate with up to twenty mobile modules 3 before a significant delay in information exchange occurs. The system uses Pico cell type topology to cover a large room.

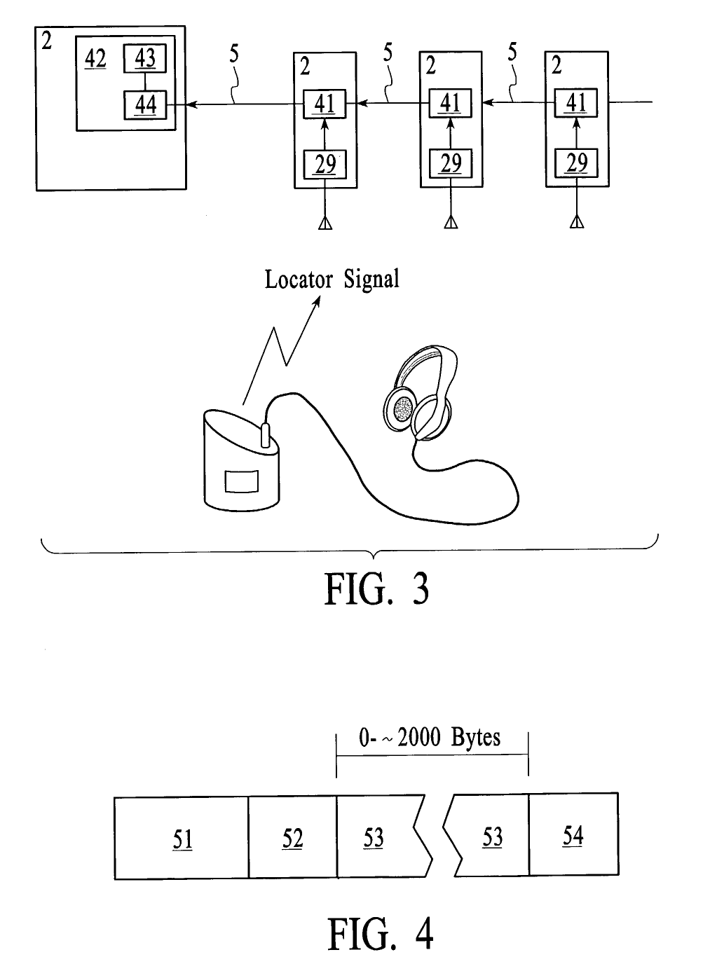

FIG. 3 is a schematic diagram showing a preferred embodiment of the tracking system. Each mobile module 3 periodically sends a locator signal. A receiver unit 29 within the base module 2 receives the locator signal. A sensor unit 41 measures the strength of the received locator signal and transmits a data packet containing this measurement to the gateway module 1. In a preferred embodiment, the locator signal is directed to a particular base module 2 and the mobile module 3 sequentially sends a signal to each of base module 2. In an alternative embodiment, the locator signal may be broadcast by the mobile module 3 and received by all base modules 2 simultaneously. Each base module 2 measures the strength of the signal it receives and transmits this information, along the cable 5 to the gateway unit 1.

The co-ordinates of each base module 2 are stored on a virtual map 43 contained in a locator unit 42 within the gateway module 1. A processor 44 within the locator unit 42 uses the signal strength data received from at least two base modules 2 to calculate the position of the mobile module 3 relative to the base modules 2 using known triangulation algorithms. Since the signal strength can be affected by various reflections within the facility from walls, equipment and people, signal strength data received from other base modules 2 is used to verify this position. Further verification is achieved by ensuring that the locator signal is send at relatively short intervals so that the mobile module 3 will not have moved far between each position fix.

The equipment control modules 4 can also measure the strength of a locator signal and transmit this information back to the gateway module 1, either to calculate the position of the mobile module 3 or as verification of a previously calculated position.

The virtual map also contains the co-ordinates of various pieces of equipment 7 within the leisure facility. It is therefore possible for the locator unit to output a signal representing a unique identifier for any piece of equipment 7 that is at the same position as the mobile module 3. It is assumed that the user to whom the mobile module 3 was allocated is using this piece of equipment 7.

If the locator unit 42 does not receive a locator signal from a particular mobile module 3 within a specified period, the mobile unit 3 is assumed to have gone out of range and an alarm is sounded to alert the facility management. In a preferred embodiment, this period is 30 seconds.

In a preferred embodiment, the locator unit 42 is implemented in software and uses the same processor and memory within the gateway module 1 as the encoder unit 22 and the multiplexer unit 23. However, it could be an independent plug-in unit.

Once the locator unit 42 has determined that a particular client is using a particular piece of equipment 7, it is possible for control information relevant to that client's training schedule to be sent to that piece of equipment 7. The gateway unit 1 stores information relating to the exercise programme of each client of the gymnasium. When a client approaches a piece of equipment, the exercise programme is checked. If the equipment is not on the client's programme or equipment is being used in the wrong order, the client is warned of their mistake via the audio system. If this warning is not heeded, a fitness trainer is notified and can investigate the situation. If the client is on the correct equipment, data from the exercise programme is sent via a base module 2 to the control module 4 connected with that training equipment in order to prepare the equipment for the client.

This automatic functionality avoids the need for the client to remember his or her exercise programme and all the detailed equipment settings. A client has no need to carry a written note of this information as the information is automatically provided as it is needed.

In a preferred embodiment, the mobile module 3 is adapted to receive signals from bio-sensors 9 placed on a body of a client. These sensors are connected to the mobile module 3 via a cable and conventional plug and socket. The sensors 9 may measure heart rate, blood pressure, body temperature or skin resistivity. A mobile unit 3 regularly samples the sensors and transmits the information via a base module 2 to the gateway unit 1. This information can then be presented to a fitness instructor to indicate how hard a client is training or how a client's fitness has improved from one training session to the next. These readings can also be used for safety reasons to give an early indication of over training that may put the health of the client at risk.

Although the present invention has been described in detail, and with particular reference to a gymnasium type environment; those skilled in the art will appreciate that the system has broader application. For example, each audio channel may be a translation of a lecture into a different language and the tracking system could be used to locate a delegate within a hotel facility. The exemplary gymnasium equipment might, for example, be substituted for door locks giving access to particular hotel facilities or to different areas of a theme park.

Those skilled in the art will also appreciate that they can make various technical changes, substitutions and alterations without departing from the scope of the invention as defined in the following claims.

1. A system for managing a leisure facility comprising:
a processing unit;
a plurality of fixed transceiver units; and
a mobile transceiver unit allocated to a customer wherein, at least two fixed transceivers receive radio signals from the mobile unit; and the processing unit uses the relative strength of the signals to determine the position of the mobile transceiver within the leisure facility.

2. A system as claimed in claim 1 wherein the mobile transceiver unit provides an audio output stream to the customer.

3. A system as claimed in claim 2 wherein the fixed transceiver unit comprises:
a plurality of buffers each associated with a different input audio channel and containing a data packet representing a sample from said audio channel; and
the mobile transceiver comprises a channel selector
wherein, the mobile unit requests a sample from a particular channel and in response, the fixed transceiver unit transmits the content of the buffer associated with the selected channel to the mobile receiver unit.

4. A system as claimed in claim 1 wherein the processing unit uses the position of the mobile transceiver unit to determine which equipment, of a plurality of equipment located within the leisure facility, is being used by the customer.

5. A system as claimed in claim 4 wherein the processing unit provides stored information about the customer to the equipment being used by the customer.

6. A system as claimed in claim 5 wherein the equipment is exercise equipment and the stored information about the customer relates to an exercise programme being followed by the customer.

7. A system as claimed in claim 5 wherein the stored information is transmitted wirelessly via the fixed transceiver units.

8. A system as claimed in claim 1 wherein the processing unit uses the position of the mobile transceiver unit to sound an alarm when a customer leaves a predetermined area.

9. A mobile transceiver unit for use in a system as claimed in claim 2.

10. A fixed transceiver unit for use in a system as claimed in claim 1.

11. In a leisure facility, a method comprising:
allocating a uniquely identifiable mobile unit to each customer;
tracking the position of the mobile unit within the facility;
using said information, in combination with stored information about a customer to control interactive equipment within the facility.

12. A method as claimed in claim 10 wherein the mobile unit provides an audio output stream to the customer.

13. A system for managing a leisure facility comprising:
a fixed transceiver unit; and
a mobile transceiver unit allocated to a customer wherein the mobile transceiver unit provides an audio output stream to the customer and transmits data to the fixed transceiver unit.

14. A system as claimed in claim 13 wherein the data transmitted to the fixed receiver unit comprises bio-data measured by sensors on the customer.

15. A system as claimed in claim 13 wherein the strength of the signal used to transmit data from the mobile transceiver unit to the fixed transceiver unit is used to calculate the position of the mobile transceiver unit.
